(19) United States
(12) Patent Application Publication
(10) Pub. No.: US 2019/0014220 A1
(43) Pub. Date: Jan. 10, 2019

(54) MOBILE DEVICE NOTIFICATION THAT UTILIZES ENVIRONMENTAL INFORMATION

(71) Applicant: THOMSON Licensing, Issy-les-Moulineaux (FR)

(72) Inventors: Joel FOGELSON, Pasadena, CA (US); William REDMANN, Glendale, CA (US)

(21) Appl. No.: 16/066,101

(22) PCT Filed: Dec. 28, 2015
(86) PCT No.: PCT/US2015/067725

§ 371 Date: Jun. 26, 2018

(51) Int. Cl. H04M 19/04; H04W 4/20; H04M 3/42

(52) U.S. Cl. CPC H04M 19/04; H04W 4/20; H04M 3/42161; H04M 3/42348; H04M 3/42357

(57) ABSTRACT

A method that generates notifications for mobile devices based on environmental factors includes detecting an event, determining at least one environmental factor value, and generating a notification based at least partly on the event and the at least one environmental factor value. Notifications for mobile devices are identified, generated, and/or modified based on environmental factors such as location, position, orientation, and proximity to other devices. User feedback may be received and used to generate and update notification profiles.

### BACKGROUND

A typical problem experienced by many mobile device users is when multiple devices are in the same area and use a common ringtone. When one of the devices receives a phone call, text message and/or electronic message, multiple mobile device users may check their devices, mistakenly thinking that they are receiving the call or message.

Similarly, many users may be annoyed by notifications that are distracting or disrupting of other activities. In addition, user may miss various notifications when an inappropriate format is used (e.g., a vibrating notification may be missed if the phone is in a bag or purse).

Thus, there is a need for methods whereby mobile devices may detect various environmental factors and choose an appropriate notification.

### SUMMARY

Some embodiments provide ways to select, generate, and/or modify notifications for mobile devices based on environmental factors. Environmental factors may include location, position, and/or orientation of the device, proximity to other devices, and/or other relevant factors.

Appropriate notifications and/or attributes may be selected or modified based on the environmental factor values. Notification attributes may include a specific ringtone, vibration pattern, light and/or color pattern, etc. Such specified attributes may attempt to maximize the likelihood of the user detecting the notification and/or otherwise improve the performance of the notification.

Notifications may be identified, generated, and/or modified in response to various detected events or received messages. Some embodiments may include notification profiles that specify a set of criteria related to the environmental factors, a set of notification attributes and/or identifiers, user information, etc.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a system whereby multiple mobile devices may communicate with one another via a network according to an exemplary embodiment;

FIG. 2 illustrates a schematic block diagram of elements of a mobile device that determines various environmental factors relating to the device;

FIG. 3 illustrates a flow chart of an exemplary client-side process of some embodiments that generates notifications based on environmental factors and relevant criteria;

FIG. 4 illustrates a flow chart of an exemplary server-side process of some embodiments that generates notifications based on environmental factors and relevant criteria for delivery to a mobile device;

FIG. 5 illustrates a flow chart of an exemplary process of some embodiments that generates and stores profiles; and

FIG. 6 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to select, generate, and/or modify notifications based on environmental factors.

A first exemplary embodiment may provide a method that generates notifications for mobile devices based on environmental factors. The method includes detecting an event, determining at least one environmental factor value, and generating a notification based at least partly on the event and the at least one environmental factor value.

A second exemplary embodiment may provide a server that generates notifications for mobile devices based on environmental information. The server includes a processor for executing a set of instructions and a non-transitory medium that stores the set of instructions. The set of instructions includes detecting an event, determining at least one environmental factor value, and generating a notification based at least partly on the event and the at least one environmental factor value.

A third exemplary embodiment may provide a mobile device that generates notifications for mobile devices based on environmental information. The mobile device includes a processor for executing a set of instructions and a non-transitory medium that stores the set of instructions. The set of instructions includes detecting an event, determining at least one environmental factor value, and generating a notification based at least partly on the event and the at least one environmental factor value.

Several more detailed embodiments are described in the sections below. Section I provides a description of system architectures used by some embodiments. Section II then describes methods of operation of some embodiments. Lastly, Section III describes a computer system which implements some of the embodiments.

### I. System Architecture

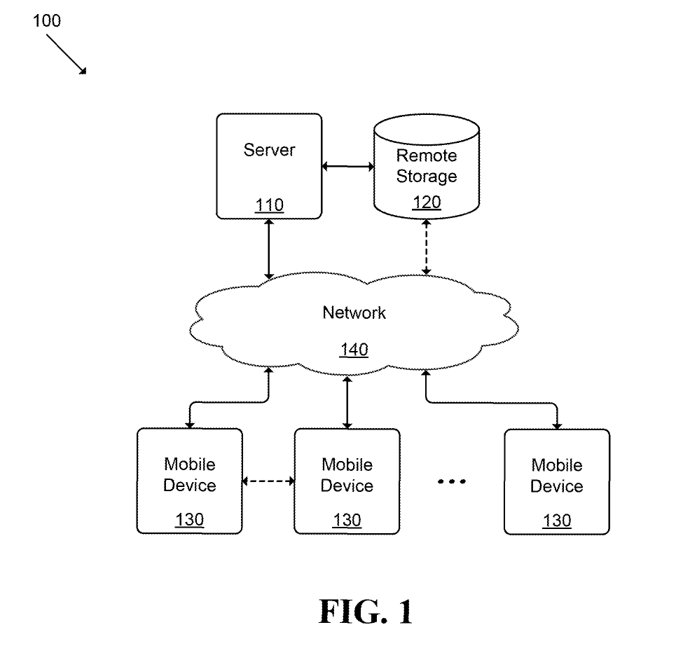

FIG. 1 illustrates a schematic block diagram of a system 100 whereby multiple mobile devices 130 may communicate with one another according to an exemplary embodiment. Specifically, this figure shows the communication pathways among the various system elements. As shown, the system may include one or more servers 110, one or more remote storages 120, one or more mobile devices 130, and one or more networks 140.

The server 110 may be an electronic computing device capable of executing instructions and/or manipulating data. The server 110 may be able to communicate across one or more networks 140 and/or interact with local devices such as remote storage 120. The server 110 may be able to retrieve and provide environmental data based upon requests received from users via different types of mobile devices 130. Additionally, server 110 may be able to retrieve and provide notifications and/or notification profiles based upon requests received from various types of mobile devices 130. Additionally, server 110 may be able to retrieve and provide notification profiles from and/or to remote storage 120.

Remote storage 120 may be an electronic device that is able to store data including notification profiles and/or provide the data to other system components. In some embodiments, the remote storage may be accessed across one or more networks 140 without requiring use of the server 110. For instance, the remote storage 120 may be accessible using one or more application programming interfaces (APIs) and/or other appropriate resources.

Network 140 may include various wired networks, wireless networks (e.g., WiFi networks, cellular networks, etc.), macro-networks (e.g., the Internet), and/or other multi-device communication pathways (e.g., Bluetooth link, tether, etc.).

During operation, a mobile device user or other appropriate user may utilize various appropriate resources to retrieve environmental data for mobile device 130. The environmental data may include the location, orientation, etc. of the device 130. Mobile device 130 may create a unique notification for mobile device 130 based on the environmental data. In some embodiments, information relating to the notification may be received by an element such as server 110. The server 110 may communicate the notification information to other mobile devices 130 in the vicinity of the server 110. Alternatively, mobile device 130 may receive from server 110 notification information for other mobile devices 130 in the vicinity of the server 110 and/or that are communicating to the server 110 through a network connection. The determination of devices in vicinity to server 110 can be performed by having such devices communicate their location (GPS) information with server 110, communicate with server 110 through an interface like Bluetooth, Wi Fi, and other wireless interfaces, a cellular connection having location information, and the like.

Additionally, environmental data may be received by an element such as server 110. The server 110 may communicate the environmental data to other mobile devices 130 in the vicinity of the server 110. Alternatively, mobile device 130 may receive from server 110 environmental data for other mobile devices 130 in the vicinity of the server 110.

In some cases, the server 110 may request notification profile information from the remote storage 120, if available. The server 110 may utilize the notification profile information to select a particular notification for mobile device 130.

In some embodiments, mobile device 130 may retrieve and/or provide environmental data and/or notification information directly to another mobile device 130 without use of server 110.

While system 100 has been described by reference to various exemplary details, one of ordinary skill in the art will recognize that the system may be implemented in various other ways without departing from the scope of the disclosure. For instance, some embodiments may include additional elements or omit some elements. As another example, the elements may be arranged in different specific ways with different communication pathways.

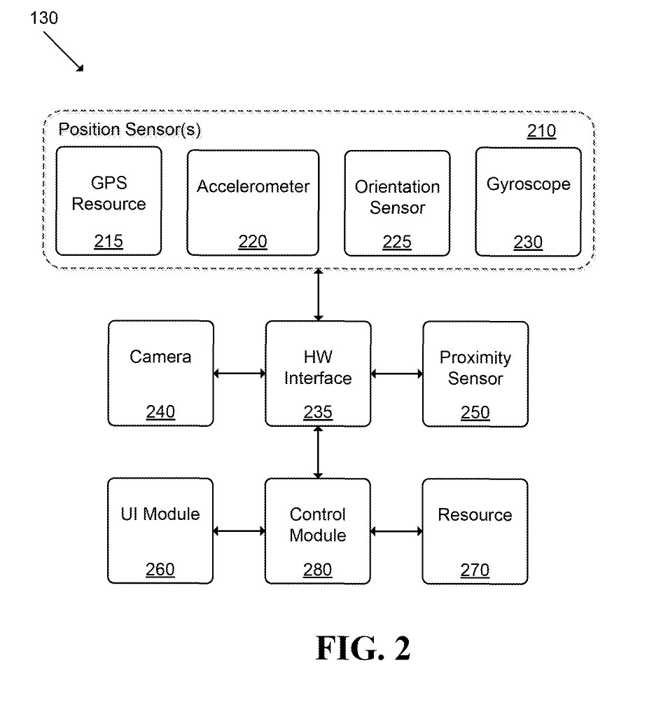

FIG. 2 illustrates a schematic block diagram of elements of a mobile device 130 that determines various environmental factors relating to the device. Specifically, this figure shows the communication pathways among the various system elements. As shown, the system may include one or more position sensors 210, one or more global positioning system (“GPS”) resources 215, one or more accelerometers 220, one or more orientation sensors 225, and one or more gyroscopes 230. The system may also include one or more hardware (“HW”) interfaces 235, one or more cameras 240, one or more proximity sensors 250, one or more user interface (“UI”) modules 260, one or more resources 270, and one or more control modules 280.

Position sensors 210 may include various sub-elements 215-230. Each sub-element may be able to receive, analyze, and/or process data relating to the physical location of mobile device 130. Each module may be able to provide data and/or instructions that are able to be used by other components to perform various processing operations.

GPS resource 215 may be a device that receives, analyzes, and/or delivers, data relating to the location and/or physical coordinates of mobile device 130. The GPS resource 215 may utilize various external resources associated with such GPS services. Accelerometer 220 may be a device that is able to sense acceleration. Such devices may be arranged in various ways in order to detect position, tilt, orientation, etc. of the mobile device 130. Orientation sensor 225 may be a device that is able to measure tilt and/or orientation of the mobile device 130. Gyroscope 230 may be may be a device that is able to measure rotation and/or orientation of mobile device 130.

Hardware interface 235 may include various elements that are able to receive and/or provide data to appropriate system hardware elements. Such hardware elements may include, for example, position sensors 210, camera 240, proximity sensor 250, UI elements such as displays, speakers, and haptic feedback elements, and/or other device hardware components.

Camera 240 may be a device that captures and/or records visual and/or is otherwise able to sense visual information such as environmental light level.

Proximity sensor 250 may be a component that is able to detect the presence of mobile devices that are in the vicinity of mobile device 130. Proximity sensor 250 may include a Wi-fi and/or Bluetooth component. Proximity sensor may identify proximate devices using internet protocol (“IP”) address, network GPS, or other appropriate ways. That is, the proximity sensor 250 can be configured as a communication interface that uses a local based communication interface such as Wi-fi/Bluetooth which has a limited range for communications, where presumptively, devices that can communicate with each other through such interfaces are close to each other. Alternatively, proximity sensor 250 can communication position information to a server 110 with location information (GPS information, for example) through a network connection, where the proximity sensor 250 can also query server 110 for other devices that are locate in an approximate area. Lastly, the proximity sensor 250 can be implemented as a cellular based interface which communicates with other devices and/or server 110 through a connection.

In addition to the sensors described above, various other elements may be used to detect environmental attributes. For instance, some embodiments may use a microphone to measure noise level and/or otherwise collect audio information. In addition, some embodiments may utilize various external sources of data when appropriate. For instance, a Wi-Fi network associated with a movie theatre may broadcast identifying information that may be used to select an appropriate notification for the location (e.g., a silent notification may be used when connected to the theater network).

UI module 260 may include various elements that are able to interact with various UI elements (e.g., a display screen, speakers, microphone, buttons, keypad, etc.) and/or receive and/or interpret commands or selections from a user. The UI module 260 may utilize the hardware interface 235.

Resource 270 may be an element capable of providing a notification to a mobile device user. The resources may include speakers, display screens, visual indicator (e.g., a light-emitting diode), haptic elements, etc. In some embodiments, the resource may be an external device that is connected to or otherwise available to the mobile device (e.g., a set of headphones, a wireless speaker, a connected display, etc.).

Control module 280 may be may be a computing device that is able to interact with UI module 260, Resource 270, hardware interface 235, and/or other system elements. Control module 280 may be able to receive and/or deliver user selection information, location data, or other data to appropriate system elements. In addition, the control module may be able to analyze environmental data, identify available notifications, and select an appropriate notification.

During operation, position sensor 210 and/or any of its various sub-elements may receive environmental data relating to the mobile device 130. The position sensors 210 may analyze and/or process the information in order to determine the location, orientation, and/or position of mobile device 130. For example, sensors 210 may determine that a user device is in a flat position, which may suggesting the device is on a table or other horizontal surface, an upright position, which may suggest the device is on a stand or in a pocket, or on a slightly angled surface, which may suggest the device is on an uneven or soft surface such as a mattress. Likewise, camera 240 may receive environmental data relating to ambient light level and/or other visual information. For example, if camera 240 detects that the environment surrounding mobile device 130 is dark, it may be likely that the device is in a pocket or purse. Likewise, if camera 240 detects a light source, it may be likely the device is outside of an enclosed space. In some embodiments, proximity sensor 250 may detect the presence of other mobile devices in proximity to mobile device 130. If multiple devices are present in one area, it is likely that multiple devices may utilize the same notification method, which may cause confusion when a call or message is received by a device.

Position sensor 210, camera 240 and/or proximity sensor 250 may deliver environmental data for mobile device 130 via hardware interface 235. The hardware interface may interact with control module 280 in order to deliver received information and/or execute commands or instructions sent by the control module 280 regarding the various hardware elements. Once the appropriate environmental information is retrieved, control module 280 may identify an appropriate notification mechanism based on the environmental data. For example, if mobile device 130 is determined to be on an uneven and/or soft surface such as a mattress, control module 280 may select an audible notification because a vibration may not be heard. As another example, if it is determined that multiple mobile devices 130 are within a close proximity to each other, the control module 280 may utilize an alternative or modified notification that is less likely to be confused with notification intended for another user.

Control module 280 may deliver the notification selection to resource 270, which may provide the notification via the mobile device. The notification may be delivered via the hardware interface 235 in some cases. In some embodiments, a user may select in advance a specific notification type for a mobile device. In addition, users may be able to select various modifications that may be used under various sets of environmental conditions.

In some embodiments, mobile device 130 may receive environmental and/or notification data from server 110 based on information received from other mobile devices 130 and/or other appropriate sources. In other embodiments, mobile device 130 may receive environmental and/or notification data from server 110 based on information received from remote storage 120 in the form of notification profiles. In other embodiments, mobile device 130 may receive environmental and/or notification data directly from other mobile devices 130 without server 110. In these embodiments, such environmental data would be received by various system elements and delivered to resource 270, which may provide the notification to the mobile device user.

While system 130 has been described by reference to various exemplary details, one of ordinary skill in the art will recognize that the system may be implemented in various other ways without departing from the scope of the disclosure. For instance, some embodiments may include additional elements or omit some elements. As another example, the elements may be arranged in different specific ways with different communication pathways.

### II. Methods of Operation

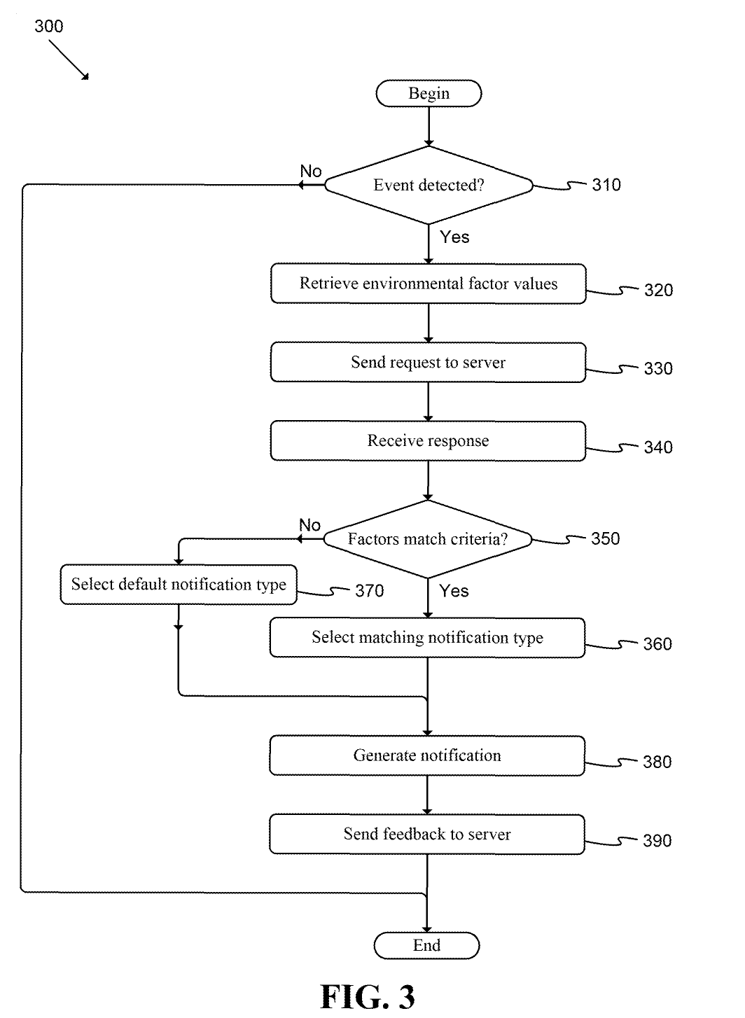

FIG. 3 illustrates a flow chart of an exemplary client-side process 300 of some embodiments that generates notifications based on environmental factors. Process 300 may be performed by a device such as mobile device 130 described above. The process may begin, for instance, when a mobile device user receives a phone call, text message or electronic message.

As shown, the process may detect (at 310) whether an event has occurred. The event may occur when, for example, a mobile device user receives a phone call, text message or electronic message. In some cases, the event may be based on some criteria monitored by the device (e.g., an alarm clock, low battery, network available, etc.).

If the process determines (at 310) that an event has not occurred, the process may end. If the process determines (at 310) that an event has occurred, the process may then retrieve (at 320) environmental factor values. The environmental factor values may be determined by mobile device 130 using the resources described in FIG. 2, and may include data relating to location, position, orientation and proximity to other devices.

Next, the process may send (at 330) a request to server. The request may include the retrieved environmental factors such as the location and/or orientation of mobile device 130 and/or whether there are multiple mobile devices 130 in the same proximate area.

The process may then receive (at 340) a response from the server. Such a response may include, for instance, an identification of a notification type (e.g., vibrate, visual, audio, etc.) or value (e.g., volume, ringtone, etc.).

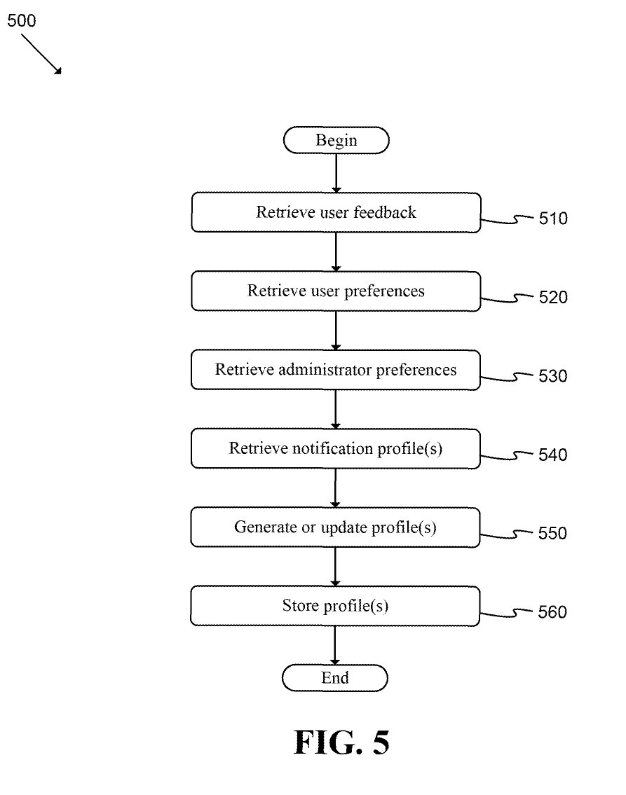

Next, the process may determine (at 350) whether the environmental factors match some specified criteria. Such criteria may be stored as profiles. For instance, light level below a threshold and phone in an upright position may indicate a phone is in a pocket. As another example, light level above a threshold and flat position may indicate the phone is face up on a table. Generation and content of profiles will be discussed in more detail in reference to FIG. 5 below.

If the process determines (at 350) that the environmental factors match the criteria, the process may then select (at 360) a matching notification type. The matching notification may be selected from various appropriate resources (e.g., a local storage of the mobile device, a server, etc.). If the process determines (at 350) the environmental factors do not match the criteria, the process may select (at 370) a default notification type. Such default notifications may include standard ringtones, vibrations, etc. that are not associated with specific environmental criteria.

Next, the process may generate (at 380) a notification. The notification may be generated at the mobile device using various appropriate UI elements (e.g., visible, audible, tactile, etc.).

Next, the process may send (at 390) feedback to a server and then may end. Such feedback may include, for example, a response to the notification (e.g., did a user immediately silence an audible notification, did a user have no response, possibly indicating that the notification was not received, etc.). In some cases, such feedback may be directly related to the notification itself (e.g., a user may indicate that a different type of notification would be preferred, the user may indicate approval of the notification type, etc.).

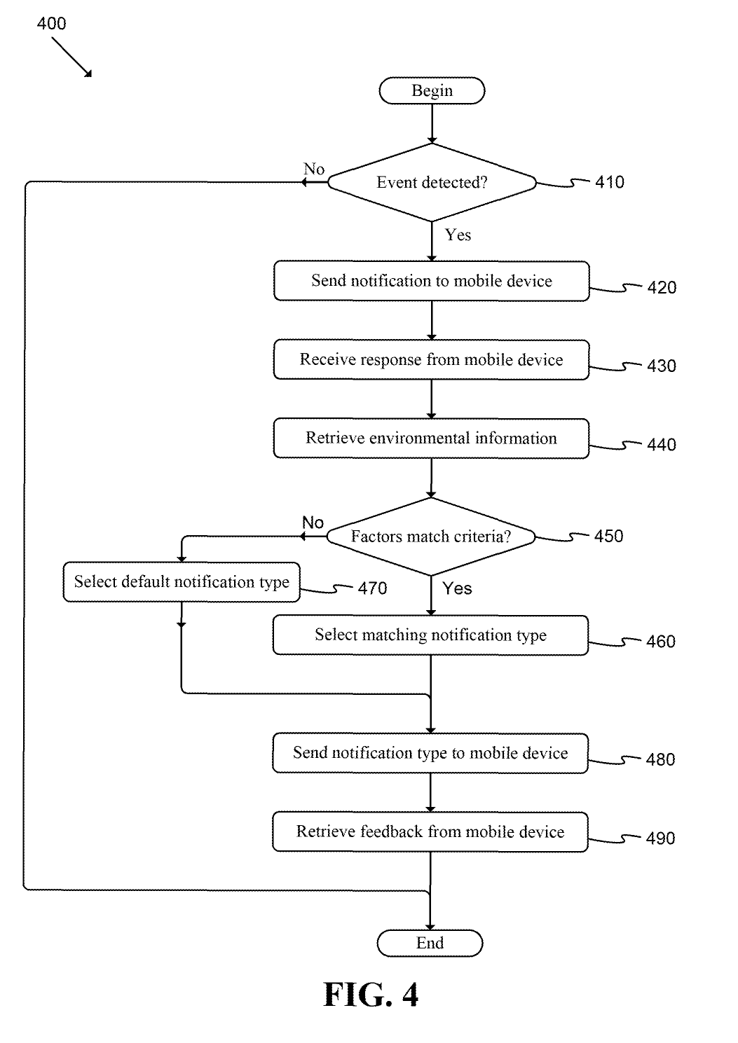

FIG. 4 illustrates a flow chart of an exemplary server-side process 400 of some embodiments that generates notifications based on environmental factors and delivers such notifications to a mobile device 130. Process 400 may be performed by a device such as server 110 described above. Such a process may be at least partly performed by a mobile device 130 using the system described in FIG. 2 that receives environmental data relating to the device. The process may begin, for instance, when a phone call, text message or electronic message is ready for delivery to a mobile device.

As shown, the process may detect (at 410) whether an event has occurred. Such an event may be identified by various appropriate resources (e.g., a cellular service, a server, the mobile device, etc.). The determination may be based on various messages received from other resources. For instance, a server of some embodiments may receive a request from a cellular provide to generate a notification related to a phone call.

If the process determines (at 410) an event has not occurred, the process may end. If the process determines (at 410) that an event has occurred, the process may then send (at 420) a notification to the mobile device. Such a notification may include various appropriate parameters such as event type (e.g., phone call, text message, etc.), identifying information (e.g., source of event, event service provider, etc.), notification information (e.g., default type or tone), and/or environmental information (e.g., status of related or nearby devices).

Next, the process may receive (at 430) response from mobile device. The response may include environmental data relating to the mobile device 130, and may include data relating to location, position, orientation and proximity to other devices. In addition, the response may include information related to device settings or parameters (e.g., ring volume, battery level, etc.).

The process may then retrieve (at 440) environmental information from other relevant sources. Such information may be related to other nearby user devices, information related to a local area network, etc.

Next, the process may determine (at 450) whether the environmental factors match specified criteria. Such criteria may be specified as profiles including sets of parameters, threshold values, etc., that are able to be used to identify relevant environmental situations. Generation and content of such profiles will be described in more detail in reference to FIG. 5 below.

If process 400 determines (at 450) that the environmental factors match the criteria, the process may then select (at 460) a matching notification type. If the process determines (at 450) the environmental factors do not match the specified criteria, the process may select (at 470) a default notification type. The notification may be an audible, visible, and/or tactile notification and may take the form of a specific ringtone, vibration pattern, light pattern, and/or color pattern.

Next, the process may send (at 480) the identified notification type (and/or other notification information such as a ringtone) to the mobile device. In some embodiments, the notification type (and/or other information) may be embedded in the message itself. In other words, a message may be sent to a device where the message includes metadata or other embedded information that provides notification parameters. Such parameters may include, for instance, type, tone, volume, etc.

Next, the process may retrieve (at 490) feedback from mobile device and then may end. Such feedback may include a user response to the notification. The received feedback may be utilized to generate and/or update the various notification profiles.

FIG. 5 illustrates a flow chart of an exemplary process 500 of some embodiments that generates and/or stores notification profiles. Process 500 may be performed by a device such as server 110. The process may begin, for instance, when feedback is received from a mobile device.

As shown, the process may retrieve (at 510) user feedback. Such feedback may be in the form of environmental data relating to mobile device 130. Such feedback may include a user response to the notification (e.g., did a user immediately silence an audible notification, indicating that the notification was intrusive, did a user have no response, indicating that the notification was not received, etc.). In some cases, such feedback may be directly related to the notification itself (e.g., a user may indicate that a different type of notification would be preferred, the user may indicate approval of the notification type, etc.).

Next, the process may receive (at 520) user preferences. Such preferences may be the selection of a specific notification type (e.g., vibrate, visual, audio, etc.) or value (e.g., volume, ringtone, etc.). In some cases, the user preference may be the selection of a specific notification type for a particular environmental situation (e.g. specific vibration pattern when in proximity to other mobile devices, audible notification when device is on a soft and/or uneven surface, etc.). The user preferences may be associated with a single user, group of users, category of users, etc.

Process 500 may then receive (at 530) administrator preferences. The administrator may be a cellular or other service provider, manufacturer, etc. The administrator preferences may include, for instance, a specific notification type (e.g., vibrate, visual, audio, etc.) or value (e.g., volume, ringtone, etc.) and/or a specific notification type for a particular environmental situation (e.g. proximity to other mobile devices, notification from the provider, etc.)

Next, the process may retrieve (at 540) any existing notification profiles. Notification profiles may be retrieved from remote storage 120 or other appropriate resources. Profiles may be retrieved based on various criteria (e.g., device type, provider, user demographic information, etc.).

As discussed above, profiles may include sets of environmental criteria (e.g., light threshold, position information, etc.). Some profiles may include matching criteria and/or thresholds across multiple parameters (e.g., multiple environmental factor values must each be within a specified range associated with that value). Criteria values may be continuous (e.g., an acceptable range) and/or discrete (e.g., match a position). Such discrete values may be defined using sub-criteria that may be continuous (e.g., “upright” may include various ranges associated with multiple input sources), and/or discrete (e.g., headphones in use).

In addition to environmental criteria, profiles may include associated notification data. Such data may include various relevant elements such as type (e.g., audible, visual, tactile, etc.), attributes (e.g., ringtone, volume, duration, etc.), etc.

Profiles may include other relevant information such as demographic information, user identity, previous selections, default values, etc. In addition, such profiles may include various matching criteria related to the other relevant factors (e.g., demographic information may include an age range).

The process may then generate or update (at 550) profiles based on the retrieved feedback, preferences, and profiles. Next, the process may store (at 560) profiles and then may end. The profiles may be stored at a resource such as remote storage 120. The profiles may be stored as discrete files (e.g., each profile may be defined by a set of one or more files), entries in a database (e.g., each profile may be stored as a set of values in a look-up table among other profiles), and/or other appropriate ways.

For example, a “pocket” profile may include criteria such as light level below a threshold and upright position. The associated notification parameters may include a type of vibration and/or an attribute specifying increase in ringtone volume.

As another example, a “table” profile may include criteria such as light level above a threshold and flat position. The associated notification parameters may include a type of audible and/or visible light pattern.

A “soft surface” profile may include criteria such as nearly horizontal position. The associated notification parameters may include an increase in ringtone volume and an override vibration command (i.e., even if a user has set the device to “vibrate only”, the soft surface profile may generate an audible or visible command).

A “purse” example may include criteria such as sideways or upright and a light source is not detected. The associated notification parameters may include a type of vibration and/or an attribute specifying an increase in ringtone volume.

As another example, a “device in use” profile may criteria such as the device being tilted at a certain height or conducting a call. The associated notification parameters may include a type and/or override of visible only.

A “car” profile may include a speed range, acceleration range, etc. that indicate travel by automobile. Such a profile may be associated with notification parameters such as disable all notifications until travel stops.

Profiles may include criteria related to proximity to other devices. For example, the notification associated with the “table” profile may be altered when multiple devices are detected to be within an area (e.g., all located on the surface of the same table) so that each device has a distinct vibration pattern or type of notification. Such proximity profiles may include specified modifications to default or standard ringtones, notification parameters (e.g., vibration length, frequency, etc.), etc. such that a user is able to differentiate the modified notification from other devices, but also recognize the notification as associated with the user's mobile device.

Profiles may also be associated with a specific user such as watching a video or mobile browsing. In such cases, a “video” or “browsing” profile may disable audible and visible notifications so as to not interrupt the user activity.

Profiles may include matching information related to device model, user group, etc. For example, a specific device model may have at least one associated notification profile.

Profiles may include links or references to other profiles. Thus, a user may select a set of profiles for use across a range of situations.

Profiles may include specified criteria related to factors such as presence, partial presence, or absence of a light source, background noise level, foreground noise level, time of day, time of year, active applications (e.g., camera, media player, etc.), device position (face up or face down, tilt and/or orientation of the device, altitude, geographic region, etc.), device motion (e.g., speed, acceleration, etc.), whether other devices in proximity are of the same or different manufacturer, etc. In addition, profiles may specify changes in values associated with the various criteria (e.g., going from light to dark past a certain hour at night may indicate the user has gone to sleep and notifications should be adjusted accordingly).

One of ordinary skill in the art will recognize that processes 300-500 are exemplary in nature and may be implemented in various ways without departing from the scope of the disclosure. For instance, the operations may be performed in different orders, different operations may be included, and/or some operations may be omitted. In addition, the processes (and/or portions thereof) may be performed concurrently, sequentially, iteratively, at regular intervals, and/or based on some specified criteria. Furthermore, each process may be performed as a part of a macro-process and/or be divided into multiple sub-processes.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

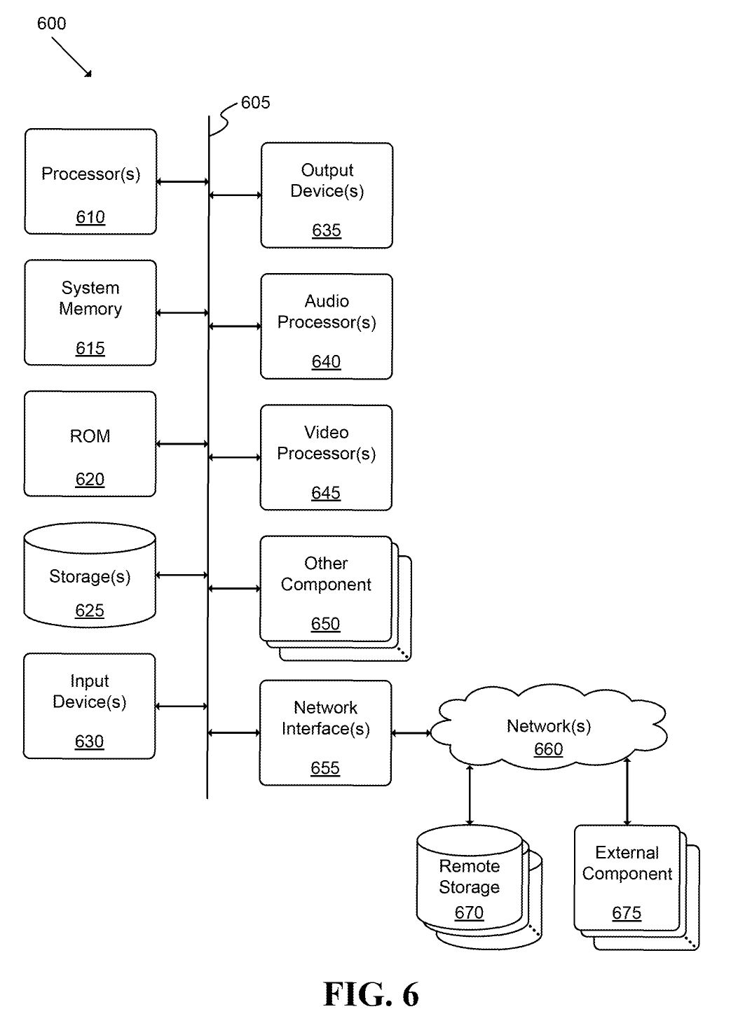

FIG. 6 illustrates a schematic block diagram of an exemplary computer system 600 used to implement some embodiments. For example, the systems described above in reference to FIG. 1 and FIG. 2 may be at least partially implemented using computer system 600. As another example, the processes described in reference to FIGS. 3-5 may be at least partially implemented using sets of instructions that are executed using computer system 600.

Computer system 600 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 600 may include at least one communication bus 605, one or more processors 610, a system memory 615, a read-only memory (ROM) 620, permanent storage devices 625, input devices 630, output devices 635, audio processors 640, video processors 645, various other components 650, and one or more network interfaces 655.

Bus 605 represents all communication pathways among the elements of computer system 600. Such pathways may include wired, wireless, optical, and/or other appropriate communication pathways. For example, input devices 630 and/or output devices 635 may be coupled to the system 600 using a wireless connection protocol or system.

The processor 610 may, in order to execute the processes of some embodiments, retrieve instructions to execute and/or data to process from components such as system memory 615, ROM 620, and permanent storage device 625. Such instructions and data may be passed over bus 605.

System memory 615 may be a volatile read-and-write memory, such as a random access memory (RAM). The system memory may store some of the instructions and data that the processor uses at runtime. The sets of instructions and/or data used to implement some embodiments may be stored in the system memory 615, the permanent storage device 625, and/or the read-only memory 620. ROM 620 may store static data and instructions that may be used by processor 610 and/or other elements of the computer system.

Permanent storage device 625 may be a read-and-write memory device. The permanent storage device may be a non-volatile memory unit that stores instructions and data even when computer system 600 is off or unpowered. Computer system 600 may use a removable storage device and/or a remote storage device as the permanent storage device.

Input devices 630 may enable a user to communicate information to the computer system and/or manipulate various operations of the system. The input devices may include keyboards, cursor control devices, audio input devices and/or video input devices. Output devices 635 may include printers, displays, audio devices, etc. Some or all of the input and/or output devices may be wirelessly or optically connected to the computer system 600.

Audio processor 640 may process and/or generate audio data and/or instructions. The audio processor may be able to receive audio data from an input device 630 such as a microphone. The audio processor 640 may be able to provide audio data to output devices 640 such as a set of speakers. The audio data may include digital information and/or analog signals. The audio processor 640 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 645 (or graphics processing unit) may process and/or generate video data and/or instructions. The video processor may be able to receive video data from an input device 630 such as a camera. The video processor 645 may be able to provide video data to an output device 640 such as a display. The video data may include digital information and/or analog signals. The video processor 645 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 650 may perform various other functions including providing storage, interfacing with external systems or components, etc.

Finally, as shown in FIG. 6, computer system 600 may include one or more network interfaces 655 that are able to connect to one or more networks 660. For example, computer system 600 may be coupled to a web server on the Internet such that a web browser executing on computer system 600 may interact with the web server as a user interacts with an interface that operates in the web browser. Computer system 600 may be able to access one or more remote storages 670 and one or more external components 675 through the network interface 655 and network 660. The network interface(s) 655 may include one or more application programming interfaces (APIs) that may allow the computer system 600 to access remote systems and/or storages and also may allow remote systems and/or storages to access computer system 600 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that generates notifications based on environmental factors, the method comprising:
detecting an event;
determining at least one environmental factor value; and
generating a notification based at least partly on the event and the at least one environmental factor value.

2. The method of claim 1 further comprising identifying a profile that matches the at least one environmental factor value.

3. The method of claim 2, wherein the profile comprises a set of environmental factor values and a set of notification attributes.

4. The method of claim 3, wherein the set of notification attributes comprises a type that is associated with at least one of an audible, visible, and tactile feedback element.

5. The method of claim 1 further comprising receiving feedback regarding the notification.

6. The method of claim 1, wherein the environmental factor values are related to at least one of a location, position, orientation, proximity, light level, and audio level.

7. The method of claim 1, wherein the event comprises receipt of one of a phone call, a text message, an electronic message, and an alarm.

8. A server that generates notifications based on environmental information, the server comprising:
a processor to execute a set of instructions; and
a memory that stores the set of instructions, wherein the set of instructions comprises:
detecting an event;
determining at least one environmental factor value; and
generating a notification based at least partly on the event and the at least one environmental factor value.

9. The server of claim 8, wherein the set of instructions further comprises identifying a profile that matches the at least one environmental factor value.

10. The server of claim 9, wherein the profile comprises a set of environmental factor values and a set of notification attributes.

11. The server of claim 10, wherein the set of notification attributes comprises a type that is associated with at least one of an audible, visible, and tactile feedback element.

12. The server of claim 8, wherein the set of instructions further comprises receiving feedback regarding the notification.

13. The server of claim 8, wherein the environmental factor values are related to at least one of a location, position, orientation, proximity, light level, and audio level.

14. The server of claim 8, wherein the event comprises receipt of one of a phone call, a text message, an electronic message, and an alarm.

15. A device that generates notifications to other devices based on environmental information, the mobile device comprising:
a processor for executing a set of instructions; and
a memory that stores the set of instructions, wherein the set of instructions comprises:
detecting an event;
determining at least one environmental factor value; and
generating a notification based at least partly on the event and the at least one environmental factor value.

16. The method of claim 15, wherein the set of instructions further comprises identifying a profile that matches the at least one environmental factor value.

17. The method of claim 16, wherein the profile comprises a set of environmental factor values and a set of notification attributes.

18. The method of claim 17, wherein the set of notification attributes comprises a type that is associated with at least one of an audible, visible, and tactile feedback element.

19. The method of claim 15, wherein the set of instructions further comprises receiving feedback regarding the notification.

20. The method of claim 15, wherein the environmental factor values are related to at least one of a location, position, orientation, proximity, light level, and audio level.

21. The method of claim 15, wherein the event comprises receipt of one of a phone call, a text message, an electronic message, and an alarm.
